(19) United States
(12) Patent Application Publication
(10) Pub. No.: US 2026/0177191 A1
(43) Pub. Date: Jun. 25, 2026

(54) DISPLAY DEVICE

(71) Applicant: LG ELECTRONICS INC., Seoul (KR)

(72) Inventors: Kangyeung LEE, Seoul (KR); Sanghoon KIM, Seoul (KR); Hyunjin JUNG, Seoul (KR)

(73) Assignee: LG ELECTRONICS INC., Seoul (KR)

(21) Appl. No.: 19/384,692

(22) Filed: Nov. 10, 2025

(30) Foreign Application Priority Data
Dec. 20, 2024 (KR) 10-2024-0192371

(51) Int. Cl. F16M 11/08; F16M 11/20

(52) U.S. Cl. CPC F16M 11/08; F16M 11/2021

(57) ABSTRACT

A display device may include: a display; a stand including: a base; a pole coupled to the base and extending vertically; and a support arm extending in a direction intersecting the pole, connecting the pole and the display, and including an elastic member, and an arm mount which is coupled to a top of the pole and to which the support arm is tiltably coupled, wherein the arm mount may include a through-hole for changing a tension of the elastic member.

### CROSS-REFERENCE TO RELATED APPLICATION

Pursuant to 35 U.S.C. § 119(a), this application claims the benefit of earlier filing date and right of priority to Korean Patent Application No. 10-2024-0192371, filed on Dec. 20, 2024, the contents of which are all hereby incorporated by reference herein in their entireties.

### BACKGROUND OF THE INVENTION

### Field of the Invention

The present disclosure relates to a display device.

### Description of the Related Art

With the development of information society, there has been a growing demand for various types of display devices. In order to meet such demand, various display devices, such as a liquid crystal display (LCD) device, a plasma display panel (PDP), an electro luminescent display (ELD), a vacuum fluorescent display (VFD), an organic light emitting diode (OLED) display, and the like, have been developed and used.

Among them, an LCD panel includes a TFT substrate and a color substrate that are opposite each other with a liquid crystal layer interposed therebetween, and can display an image using light provided from a backlight unit. In addition, an OLED panel can display an image by depositing a self-luminescent organic layer on a substrate having a transparent electrode formed thereon.

Recently, numerous research has been conducted on a structure for freely adjusting the angle or position of a display.

### SUMMARY OF THE INVENTION

It is an object of the present disclosure to solve the above and other problems.

Another object of the present disclosure may be to provide a display device including a stand for supporting a display.

Another object of the present disclosure may be to provide a structure for freely adjusting the angle or height of a display.

Another object of the present disclosure may be to provide a rotational structure of a support arm of a display.

Another object of the present disclosure may be to provide a structure for supporting rotation of a support arm.

Another object of the present disclosure may be to provide a structure for adjusting the tension of an elastic member of a support arm.

Another object of the present disclosure may be to provide a stopper structure for restricting rotation of a support arm.

Another object of the present disclosure may be to provide a joint structure for connecting a support arm to a display.

Another object of the present disclosure may be to provide a structure in which a cable is disposed between a joint and a joint cover.

In accordance with an aspect of the present disclosure for the above and other objects, a display device may include: a display; a stand including: a base; a pole coupled to the base and extending vertically; and a support arm extending in a direction intersecting the pole, connecting the pole and the display, and including an elastic member, and an arm mount which is coupled to a top of the pole and to which the support arm is tiltably coupled, wherein the arm mount may include a through-hole for changing a tension of the elastic member.

### BRIEF DESCRIPTION OF THE DRAWINGS

The above and other objects, features and advantages of the present invention will be more apparent from the following detailed description in conjunction with the accompanying drawings, in which:

FIGS. 1 to 31 are diagrams illustrating examples of a display device according to embodiments of the present disclosure.

### DETAILED DESCRIPTION

Description will now be given in detail according to exemplary embodiments disclosed herein, with reference to the accompanying drawings. For the sake of brief description with reference to the drawings, the same or equivalent components may be denoted by the same reference numbers, and description thereof will not be repeated.

In the following description, a suffix such as “module” and “unit” may be used to refer to elements or components. Use of such a suffix herein is merely intended to facilitate description of the specification, and the suffix itself is not intended to give any special meaning or function.

In the present disclosure, that which is well known to one of ordinary skill in the relevant art has generally been omitted for the sake of brevity. The accompanying drawings are used to help easily understand various technical features and it should be understood that the embodiments disclosed herein are not limited by the accompanying drawings. As such, the present disclosure should be construed to extend to any alterations, equivalents, and substitutes in addition to those which are particularly set out in the accompanying drawings.

Although the terms “first”, “second”, etc. may be used herein to describe various elements, these elements should not be limited by these terms. These terms are only used to distinguish one element from another.

When an element is referred to as being “coupled”, “fixed”, “mounted”, “connected” or “linked” to another element, intervening elements may also be present. In contrast, when an element is referred to as being “directly coupled”, “directly fixed”, “directly mounted”, “directly connected” or “directly linked” to another element, there are no intervening elements present.

A singular representation may include a plural representation unless the context clearly indicates otherwise.

Terms such as “comprises or includes” or “has” are used herein and should be understood that they are intended to indicate an existence of features, numbers, steps, operations, elements, components, or combinations thereof, disclosed in the specification, but do not preclude the presence or addition of one or more other features, numbers, steps, operations, elements, components, or combinations thereof.

The directions “up (U)”, “down (D)”, “left (Le)”, “right (Ri)”, “front (F)”, and “rear (R)” shown in the drawings are used only for convenience of description, and the technical concept disclosed in this specification is not limited by these directions.

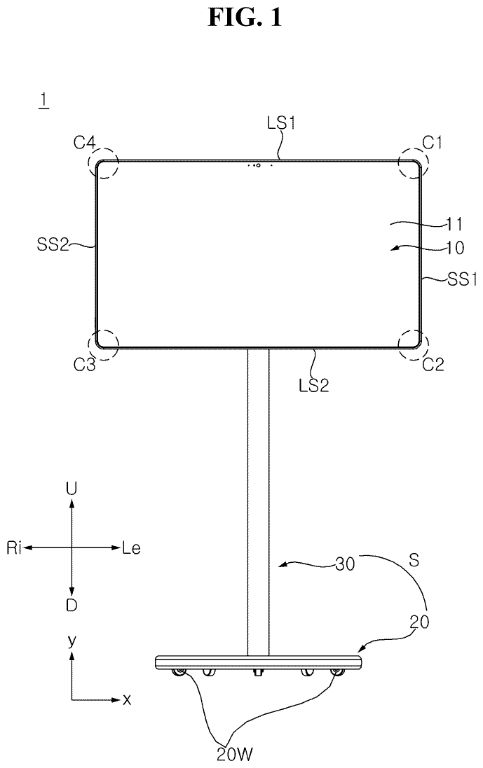

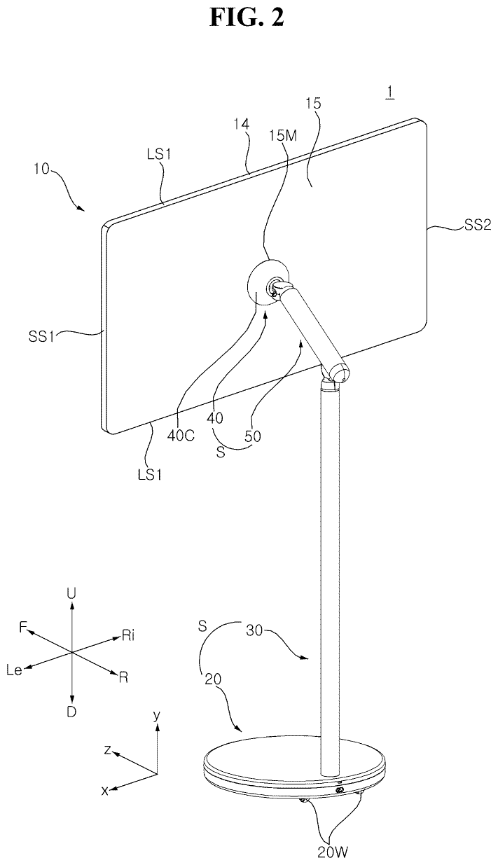

Referring to FIGS. 1 and 2, a display device 1 may include a display 10. The display 10 may include a display panel 11 to display an image. The image may be displayed on a front surface of the display panel 11. The display 10 may be referred to as a display unit 10 or a head 10.

The display 10 may include a first long side LS1, a second long side LS2 opposite the first long side LS1, a first short side SS1 adjacent to the first long side LS1 and the second long side LS2, and a second short side SS2 opposite the first short side SS1. Meanwhile, for ease of explanation, it is illustrated and described that lengths of the first and second long sides LS1 and LS2 are greater than lengths of the first and second short sides SS1 and SS2, but the lengths of the first and second long sides LS1 and LS2 may be substantially equal to the lengths of the first and second short sides SS1 and SS2.

A direction parallel to the short sides SS1 and SS2 of the display 10 may be referred to as an up-and-down direction. A direction parallel to the long sides LS1 and LS2 of the display 10 may be referred to as a left-and-right direction. A direction perpendicular to the short sides SS1 and SS2 and the long sides LS1 and LS2 of the display 10 may be referred to as a front-and-rear direction.

A direction in which the display 10 displays an image may be referred to as a front (F, z), and a direction opposite to the front may be referred to as a rear (R). The first short side SS1 may be referred to as a left side (Le, x). The second short side SS2 may be referred to as a right side (Ri). The first long side LS1 may be referred to as an upper side (U, y). The second long side LS2 may be referred to as a lower side (D).

The first long side LS1, the second long side LS2, the first short side SS1, and the second short side SS2 may be referred to as edges of the display 10. Points where the first long side LS1, the second long side LS2, the first short side SS1, and the second short side SS2 meet one another may be referred to as corners. A point where the first long side LS1 and the first short side SS1 meet may be referred to as a first corner C1. A point where the first short side SS1 and the second long side LS2 meet may be referred to as a second corner C2. A point where the second long side LS2 and the second short side SS2 meet may be referred to as a third corner C3. A point where the second short side SS2 and the first long side LS1 meet may be referred to as a fourth corner C4.

A stand S may support the display 10. The stand S of the display device 1 may be placed on a surface (e.g., a floor, the ground, etc.), thereby allowing the display 10 of the display device 1 to be spaced apart from the surface. The stand S may include a base 20, a pole 30, a connector 40, and a support arm 50.

The base 20 may be placed on a surface. The base 20 may be rounded or angled. A plurality of wheels 20W may be mounted to the base 20. The base 20 may be referred to as a moving base 20.

The pole 30 may extend from the base 20. A longitudinal direction of the pole 30 may be parallel to the vertical direction. A lower end of the pole 30 may be coupled to the base 20 to be adjacent to a periphery of the base 20.

The support arm 50 may extend in a direction intersecting the pole 30. The support arm 50 may be coupled to the pole 30 to be adjacent to an upper end of the pole 30. The connector 40 may be disposed between the display 10 and the pole 30, and may be coupled to the display 10 and the pole 30.

Accordingly, the display 10 may be supported by the stand S, and may be spaced apart from the surface on which the base 20 is placed.

Meanwhile, a battery (not shown) may be embedded in at least one of the base 20, the pole 30, the support arm 50, or the display 10. The display device 1 may be driven by power supplied from the battery.

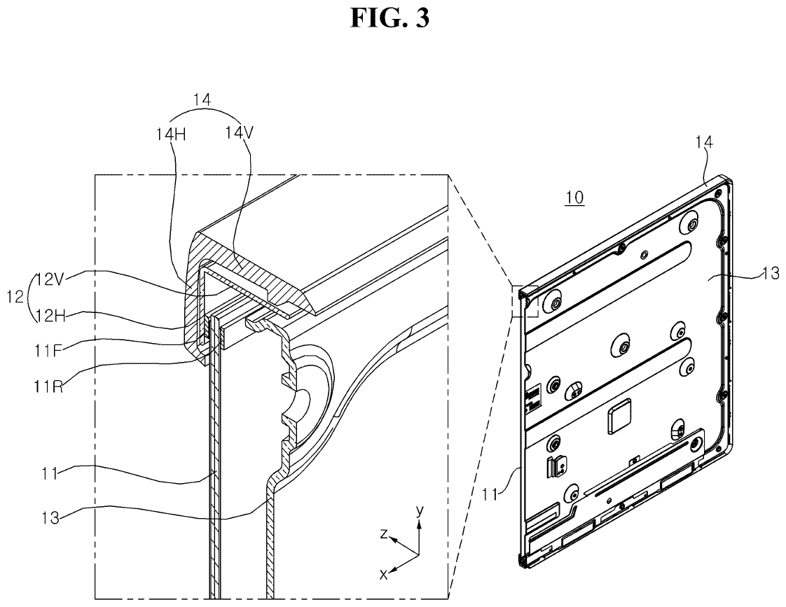

Referring to FIG. 3, the display 10 may include a display panel 11, a middle cabinet 12, a frame 13, a side frame 14, and a back cover 15 (see FIG. 2).

The display panel 11 may define a front surface of the display 10. For example, the display panel 11 may be a liquid crystal display (LCD) panel, an organic light emitting diode (OLED) panel, or a light emitting diode (LED) panel. The display panel 11 may include a plurality of pixels to output an image in accordance with color, brightness, and chroma of each pixel. The display panel 11 may be divided into an active area in which an image is displayed and a de-active area in which no image is displayed. The display panel 11 may generate light corresponding to red, green or blue color in response to a control signal.

The middle cabinet 12 may extend along an edge of the display panel 11. A horizontal portion 12H may be positioned at the front of the display panel 11. A vertical portion 12V may intersect the horizontal portion 12H, and may cover a side surface of the display panel 11. In some embodiments, the middle cabinet 12 may be omitted. A front pad 11F may be disposed between the horizontal portion 12H and the display panel 11, and may be coupled to the horizontal portion 12H. A rear pad 11R may opposite to the front pad 11F with respect to the display panel 11.

The frame 13 may be positioned behind the display panel 11. Electronic components such as a printed circuit board (PCB) may be mounted on the frame 13. For example, a power supply board, a timing controller board, and a main board may be coupled to the rear of the frame 13.

The side frame 14 may extend along an edge of the frame 13. The side frame 14 may define an edge of the display 10. A horizontal portion 14H may be positioned at the front of the horizontal portion 12H of the middle cabinet 12. A vertical portion 14V may cover the vertical portion 12V of the middle cabinet 12.

The back cover 15 may define a rear surface of the display 10. The back cover 15 may cover the rear of the frame 13, and may be coupled to the frame 13.

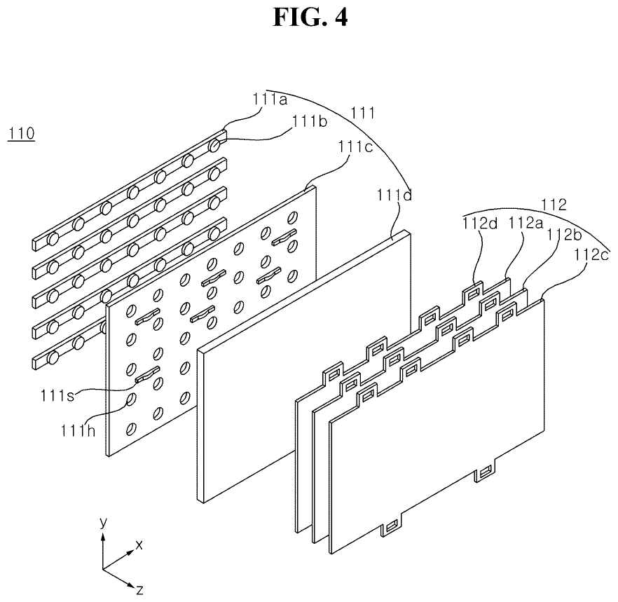

Referring to FIGS. 3 and 4, a backlight unit 110 may be disposed between the display panel 11 and the frame 13, and may be coupled to the frame 13. The display panel 11 may be referred to as an LCD panel 11. The backlight unit 110 may include an optical layer 111 and an optical sheet 112.

The optical layer 111 may include a substrate 111a, at least one light source 111b such as a light emitting diode (LED), a reflective sheet 111c, and a diffusion plate 111d. The reflective sheet 111c may include a hole 111h in which the light source 111b is positioned. The diffusion plate 111d may be positioned at the front of the reflective sheet 111c. A spacer 111s may support a rear surface of the diffusion plate 111d between the reflective sheet 111c and the diffusion plate 111d.

The optical sheet 112 may be positioned at the front of the diffusion plate 111d. The optical sheet 112 may include at least one of a diffusion sheet or a prism sheet. For example, the optical sheet 112 may be composed of a plurality of layers 112a, 112b and 112c. A coupling portion 112d of the optical sheet 112 may be coupled to the frame 13.

Accordingly, light from the light source 111b may be provided to the display panel 11 through the diffusion plate 111d and the optical sheet 112. Meanwhile, the display panel 11 of the present disclosure may be an OLED panel that does not require the backlight unit 110 described above or another type of panel.

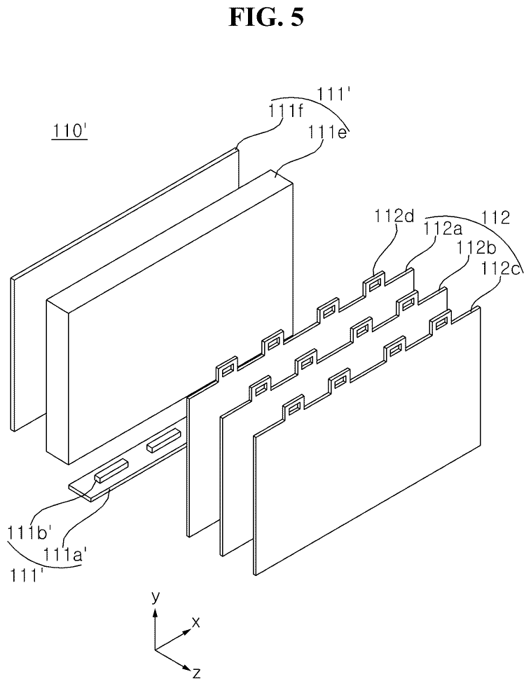

Referring to FIGS. 3 and 5, a backlight unit 110′ may be disposed between the display panel 11 and the frame 13, and may be coupled to the frame 13. The display panel 11 may be referred to as an LCD panel 11. The backlight unit 110′ may include an optical layer 111′ and an optical sheet 112.

The optical layer 111′ may include a substrate 111a′, at least one light source 111b′ such as a light emitting diode (LED), a reflective sheet 111f, and a light guide plate 111e. The light guide plate 111e may be disposed between the frame 13 and the optical sheet 112, and may be supported by the frame 13. The reflective sheet 111f may be disposed between the frame 13 and the light guide plate 111e, and may be supported by the frame 13.

Accordingly, light from the light source 111b′ may be provided to the display panel 11 through the light guide plate 111e and the optical sheet 112. Meanwhile, the display panel 11 of the present disclosure may be an OLED panel that does not require the backlight unit 110′ described above or another type of panel.

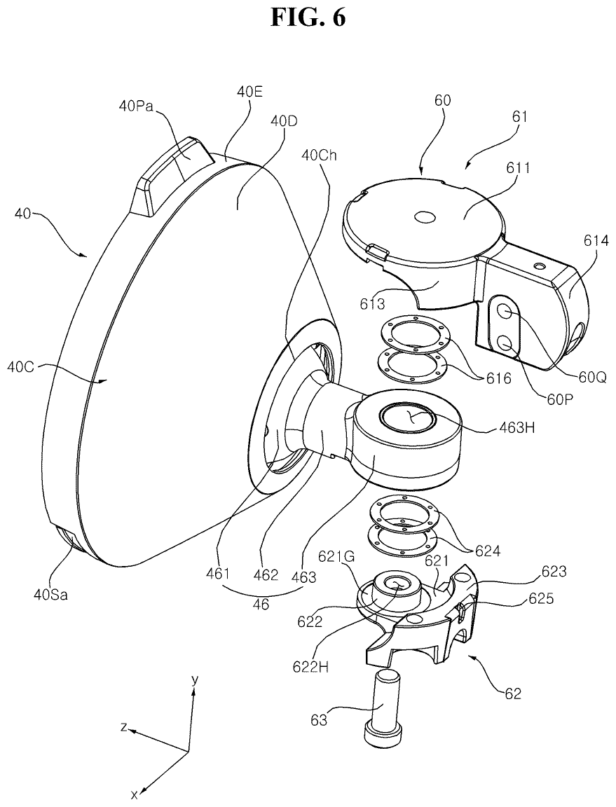

Referring to FIG. 6, a cover 40C of the connector 40 may have a bowl shape that is open at the front. The cover 40C may include a dome 40D and a side wall 40E. A cover hole 40Ch may be formed in the cover 40C. A holder 46 of the connector 40 may pass through the cover hole 40Ch. The holder 46 may include a front part 461, a middle part 462, and a rear part 463. The front part 461 may define a front portion of the holder 46, and may be disposed within the cover 40C. The middle part 462 may extend rearward from the front part 461, and may define a middle portion of the holder 46. The rear part 463 may extend rearward from the middle part 462, and may define a rear portion of the holder 46. The rear part 463 may have a generally ring shape. A hole 463H may be formed through a central portion of the rear part 463 in the vertical direction.

A joint 60 may include an upper body 61 and a lower body 62. The joint 60 may be referred to as a front joint 60, an arm joint 60, a first joint 60, a swivel bracket 60, or a bracket 60.

The upper body 61 may be coupled to a top of the rear part 463 of the holder 46. The upper body 61 may be referred to as an upper bracket 61, a top bracket 61, or a first bracket 61.

The lower body 62 may be coupled to a bottom of the rear part 463 of the holder 46. The lower body 62 may be referred to as a lower bracket 62, a bottom bracket 62, or a second bracket 62.

The rear part 463 of the holder 46 may be positioned between the upper body 61 and the lower body 62.

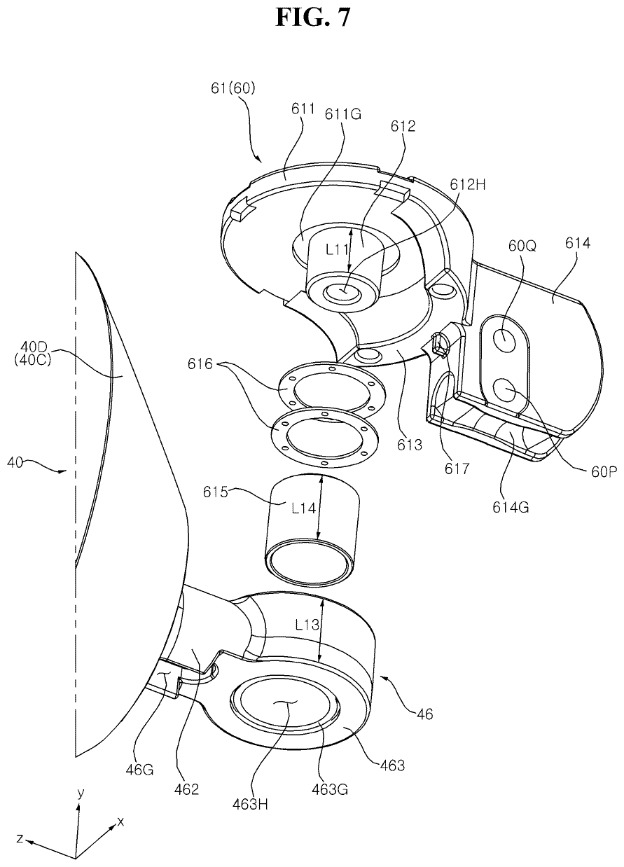

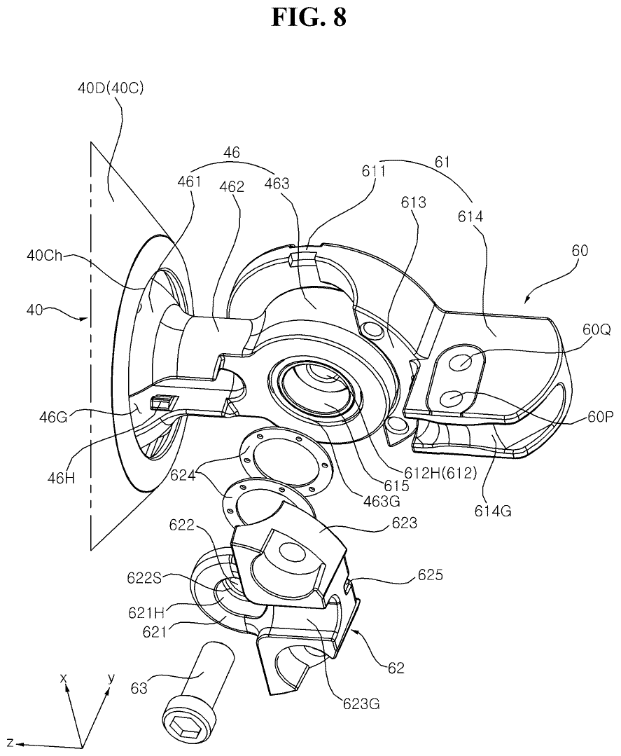

Referring to FIGS. 7 and 8, the upper body 61 may include an upper base 611, an upper pin 612, an upper wall 613, and a coupler 614.

The upper base 611 may define an upper surface of the joint 60. The upper base 611 may have a generally circular plate shape. The upper base 611 may be referred to as a first base 611.

The upper pin 612 may protrude from a lower surface of the upper base 611. The upper pin 612 may have a cylindrical shape. The upper pin 612 may be aligned with the hole 463H of the rear part 463 of the holder 46. An outer diameter of the upper pin 612 may be equal to or less than a diameter of the hole 463H of the rear part 463. A length L11 of the upper pin 612 may be less a length L13 of the hole 463H of the rear part 463. The upper pin 612 may be inserted into the hole 463H of the rear part 463. The upper pin 612 may be referred to as a first pin 612.

A bushing 615 may be positioned between an outer circumferential surface of the upper pin 612 and an inner surface (i.e., a boundary) of the hole 463H. The bushing 615 may have a hollow cylindrical shape. An outer diameter of the bushing 615 may be equal to or less than the diameter of the hole 463H. An inner diameter of the bushing 615 may be equal to or greater than the outer diameter of the upper pin 612. A length L14 of the bushing 615 may be greater than the length L11 of the upper pin 612. The length L14 of the bushing 615 may be equal to or less than the length L13 of the hole 463H. The upper pin 612 may be inserted into the bushing 615. In some embodiments, the bushing 615 may be omitted.

A washer 616 may be disposed between the rear part 463 and the upper base 611. The upper pin 612 may pass through the washer 616. The washer 616 may be positioned on an upper surface of the rear part 463. A portion of the washer 616 may be positioned on the bushing 615. The washer 616 may be positioned on the lower surface of the upper base 611. A groove 611G may be recessed from the lower surface of the upper base 611, and may extend along the upper pin 612. The washer 616 may be positioned on the groove 611G. One or two or more washers 616 may be provided.

The upper wall 613 may protrude from the lower surface of the upper base 611. The upper wall 613 may extend along a portion of a lateral surface of the rear part 463. The upper wall 613 may cover the portion of the lateral surface of the rear part 463. A lower end of the upper wall 613 may be located at a higher position than a lower surface of the rear part 463. The upper wall 613 may be referred to as a first wall 613.

The coupler 614 may protrude from an outer surface of the upper wall 613. The coupler 614 may extend from the upper wall 613 in a radial direction of the upper wall 613. A lower end of the coupler 614 may be located at a lower position than the lower end of the upper wall 613. The coupler 614 may be referred to as a coupling part 614, a supporter 614, a link bracket 614, or a bracket 614.

A guide protrusion 617 may be adjacent to a boundary between a lower surface of the upper wall 613 and the coupler 614. The guide protrusion 617 may protrude from the lower surface of the upper wall 613 and/or a front surface of the coupler 614.

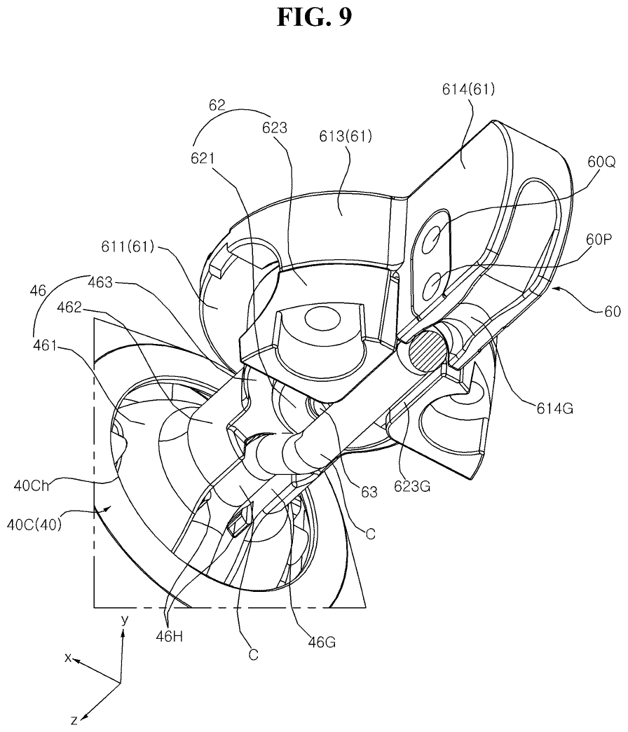

Referring to FIGS. 8 and 9, the lower body 62 may include a lower base 621, a lower pin 622, and a lower wall 623.

The lower base 621 may define a lower surface of the joint 60. The lower base 621 may have a generally ring shape. A through-hole 621H may be formed in the lower base 621. The lower base 621 may be referred to as a second base 621.

The lower pin 622 may protrude from an upper surface of the lower base 621. The lower pin 622 may have a hollow cylindrical shape. A hollow space 622H (see FIG. 6) of the lower pin 622 may be aligned with the through-hole 621H and the hole 463H of the rear part 463. The hollow space 622H may be referred to as a hole 622H. An inner diameter of the lower pin 622 may be less than a diameter of the through-hole 621H. An outer diameter of the lower pin 622 may be equal to or less than the diameter of the hole 463H of the rear part 463. The outer diameter of the lower pin 622 may be equal to or less than the inner diameter of the bushing 615. The lower pin 622 may be inserted into the bushing 615, and may face the upper pin 612. The lower pin 622 may be referred to as a second pin 622.

A washer 624 may be disposed between the lower base 621 and the rear part 463. The lower pin 622 may pass through the washer 624. The washer 624 may be positioned on the upper surface of the lower base 621. A groove 621G (see FIG. 6) may be recessed from the upper surface of the lower base 621, and may extend along the lower pin 622. The washer 624 may be positioned on the groove 621G. The washer 624 may be positioned on the lower surface of the rear part 463. A groove 463G may be recessed from the lower surface of the rear part 463, and may extend along the hole 463H. The washer 624 may be positioned on the groove 463G. A portion of the washer 624 may be positioned on the bushing 615. One or two or more washers 624 may be provided.

The lower wall 623 may protrude from the upper surface of the lower base 621. The lower wall 623 may protrude from a lower surface of the lower base 621. An upper end of the lower wall 623 may be located at a higher position than an upper end of the lower base 621. A lower end of the lower wall 623 may be located at a lower position than a lower end of the lower base 621. The lower wall 623 may extend along a portion of a lateral surface of the rear part 463. The lower wall 623 may cover the portion of the lateral surface of the rear part 463. The lower wall 623 may face the upper wall 613. A flat upper surface of the lower wall 623 and a flat lower surface of the upper wall 613 may be in contact with each other. The lower wall 623 may be referred to as a second wall 623.

A guide groove 625 may be formed on the upper surface of the lower wall 623. The guide protrusion 617 of the upper body 61 may be inserted into the guide groove 625 of the lower body 62. The guide protrusion 617 and the guide groove 625 may guide the coupling of the upper body 61 and the lower body 62. Alternatively, a guide protrusion may protrude from the upper surface of the lower wall 623, and a guide groove into which the guide protrusion is inserted may be formed in the upper wall 613.

A fastening member 63 may pass through the through-hole 621H of the lower base 621 and the hollow space 622H of the lower pin 622 and be coupled to a hole 612H of the upper pin 612. The hole 612H may be referred to as a hollow space 612H of the upper pin 612. The fastening member 63 may be a bolt, a screw, or a rivet. A body of the fastening member 63 may be screw-coupled to an inner surface of the hole 612H of the upper pin 612. A head of the fastening member 63 may be caught on a stepped portion 622S between an inner surface (i.e., a boundary) of the through-hole 621H and an inner circumferential surface of the lower pin 622. The stepped portion 622S may be a lower end of the lower pin 622.

Accordingly, the lower body 62 may be coupled to the upper body 61 by the fastening member 63. The fastening member 63 may press the upper body 61 and the lower body 62 toward the rear part 463 of the holder 46. The rear part 463 of the holder 46 may be sandwiched between the upper body 61 and the lower body 62.

The pins 612 and 622 of the joint 60 may provide a swivel axis for the connector 40 including the holder 46. The holder 46 may be rotated about the pins 612 and 62, namely, be swiveled. Due to frictional forces between the rear part 463 and the bases 611 and 621, a force of a predetermined magnitude or greater may be required to rotate the holder 46. Meanwhile, the joint 60 may further include a disc spring to increase a frictional force of the holder 46. The disc spring may include at least one of a first disc spring or a second disc spring.

The first disc spring may be positioned between the upper surface of the rear part 463 and the lower surface of the upper base 611. The upper pin 612 may pass through the first disc spring. The first disc spring may be disposed between the upper surface of the rear part 463 and the washer 616, or may be disposed between the washer 616 and the lower surface of the upper base 611. The first disc spring may be convex upward or downward, and may have elasticity. The first disc spring may generate an elastic force in an axial direction, thereby increasing the frictional force between the rear part 463 and the upper base 611.

The second disc spring may be positioned between the lower surface of the rear part 463 and the upper surface of the lower base 621. The lower pin 622 may pass through the second disc spring. The second disc spring may be disposed between the lower surface of the rear part 463 and the washer 624, or may be disposed between the washer 624 and the upper surface of the lower base 621. The second disc spring may be convex upward or downward, and may have elasticity. The second disc spring may generate an elastic force in an axial direction, thereby increasing the elastic force between the rear part 463 and the lower base 621.

The rotation of the holder 46 with respect to the pins 612 and 622 may be limited or restricted as the middle part 462 of the holder 46 contacts one end or the other end of the walls 613 and 623. For example, the connector 40 including the holder 46 may be swiveled within a range of +90 to −90 degrees.

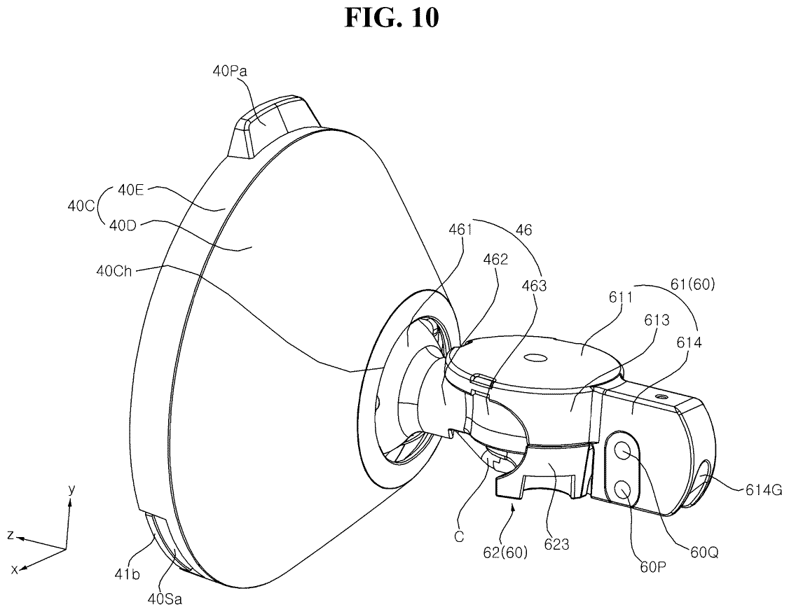

Referring to FIGS. 9 and 10, a cable groove 623G may be formed on a lower surface of the lower wall 623. A cable groove 614G may be formed on a lower surface of the coupler 614.

A cable C positioned in a cable groove 46G of the holder 46 may be positioned in the cable groove 623G of the lower body 62 and the cable groove 614G of the upper body 61. That is, the cable C may be routed into the holder 46 and the joint 60.

A protrusion 46H may protrude from a side wall of the cable groove 46G. One of a pair of protrusions 46H may protrude from a first side wall of the cable groove 46G, and the other may protrude from a second side wall of the cable groove 46G that is opposite the first side wall. The cable C may be inserted into the cable groove 46G, and may be engaged with the protrusion 46H.

The connector 40 may be coupled to a mount 15M (see FIG. 2) of the back cover 15. Specifically, the mount 15M may be recessed from a rear surface of the back cover 15, and the connector 40 may be inserted into the mount 15M. A protruding portion 40Pa formed at a side wall 40E of the connector 40 may be inserted into a groove formed at a side wall of the mount 15M. A protrusion protruding from the side wall of the mount 15M may be inserted into a groove 40Sa formed at the side wall 40E of the connector 40. Here, a portion 41b forming a front surface of the connector 40 may form the groove 40Sa.

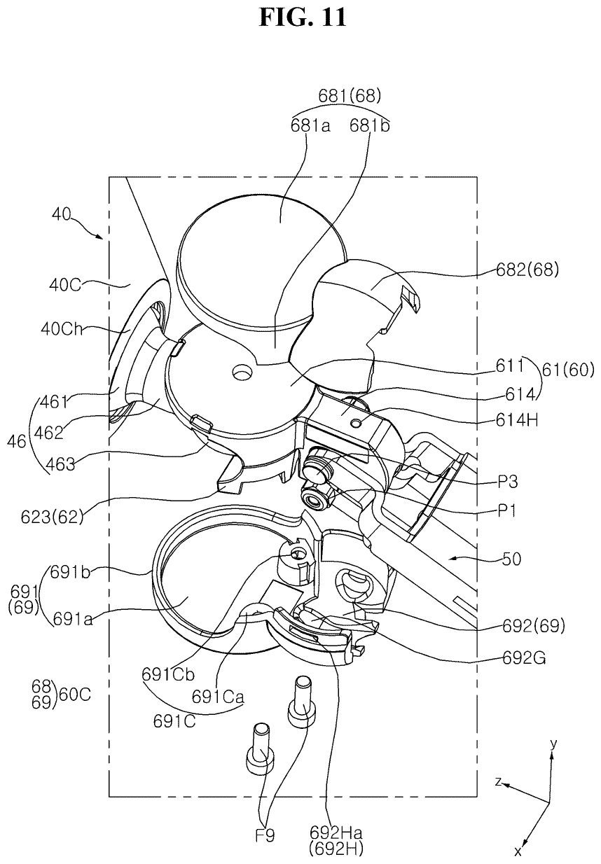

Referring to FIG. 11, a cover 60C may include a top cover 68 and a bottom cover 69. The cover 60C may be referred to as a joint cover 60C or a joint case 60C.

The top cover 68 may be positioned over the upper body 61 of the joint 60. The top cover 68 may be referred to as an upper cover 68 or a first cover 68.

The bottom cover 69 may be positioned under the lower body 62 of the joint 60. The bottom cover 69 may be referred to as a lower cover 69 or a second cover 69.

The joint 60 may be positioned between the top cover 68 and the bottom cover 69.

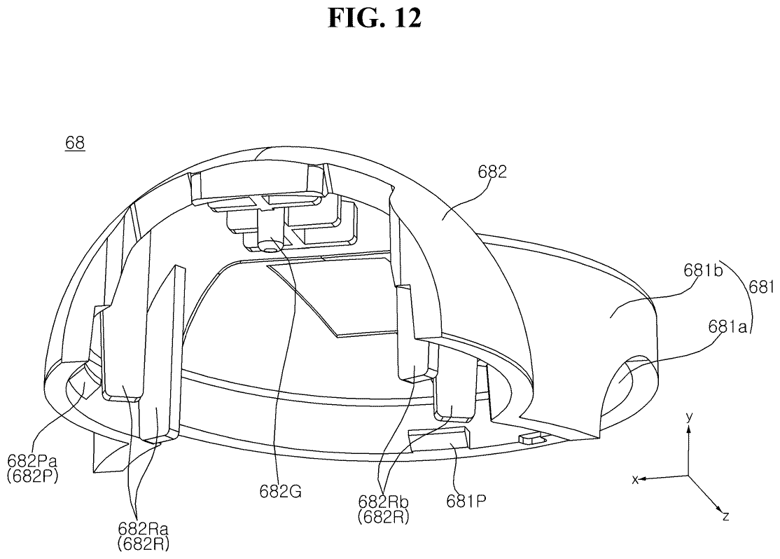

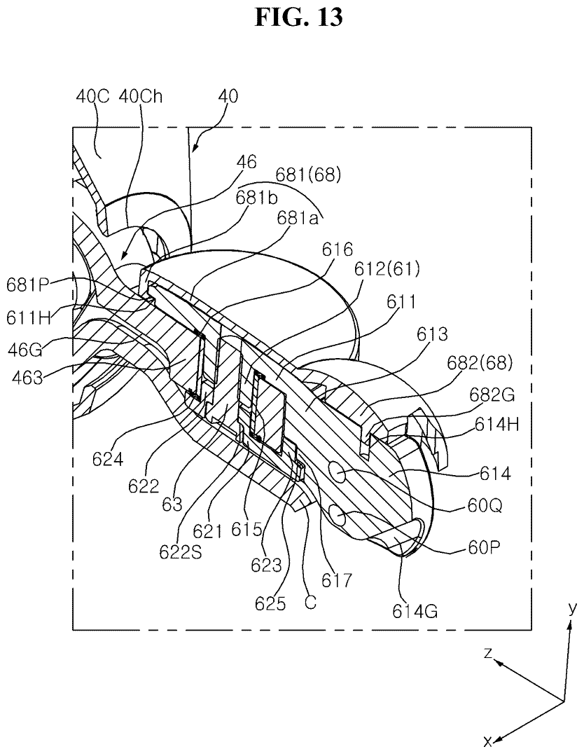

Referring to FIGS. 12 and 13, the top cover 68 may include a top base 681 and a top dome 682.

The top base 681 may face an upper surface of the upper base 611 of the upper body 61. The top base 681 may have a generally circular plate shape. A side wall 681b of the top base 681 may protrude downward from an edge of a top 681a of the top base 681, and may extend along the edge. A protrusion 681P may protrude from an inner surface of the side wall 681b. The protrusion 681P may be referred to as a hook 681P.

The top dome 682 may extend rearward from the top base 681. The top dome 682 may cover the coupler 614 of the upper body 61. The top dome 682 may have a generally dome shape that is convex upward. A protrusion 682P may protrude from an inner surface of the top dome 682. A first protrusion 682Pa and a second protrusion 682Pb may be positioned opposite each other in the horizontal direction.

A guide pin 682G may be adjacent to a top of the top dome 682 so as to protrude from an inside of the top dome 682. A guide rib 682R may protrude from the inner surface of the top dome 682, and may be adjacent to the protrusion 682P. A first guide rib 682Ra may be spaced spart from the first protrusion 682Pa while being adjacent thereto. The first guide rib 682Ra may be provided in pair. A second guide rib 682Rb may be spaced spart from the second protrusion 682Pb while being adjacent thereto. The second guide rib 682Rb may be provided in pair.

A groove 611H or a hole 611H may be formed in the upper base 611, and may be positioned to correspond to the protrusion 681P of the top base 681. The protrusion 681P may be hooked into the groove 611H. Accordingly, the top cover 68 may be coupled to the upper body 61.

A guide hole 614H may be formed in the coupler 614, and may be positioned to correspond to the guide pin 682G of the top dome 682. The guide pin 682G may be inserted into the guide hole 614H. Accordingly, the guide pin 682G and the guide hole 614H may guide the coupling of the top cover 68 and the upper body 61.

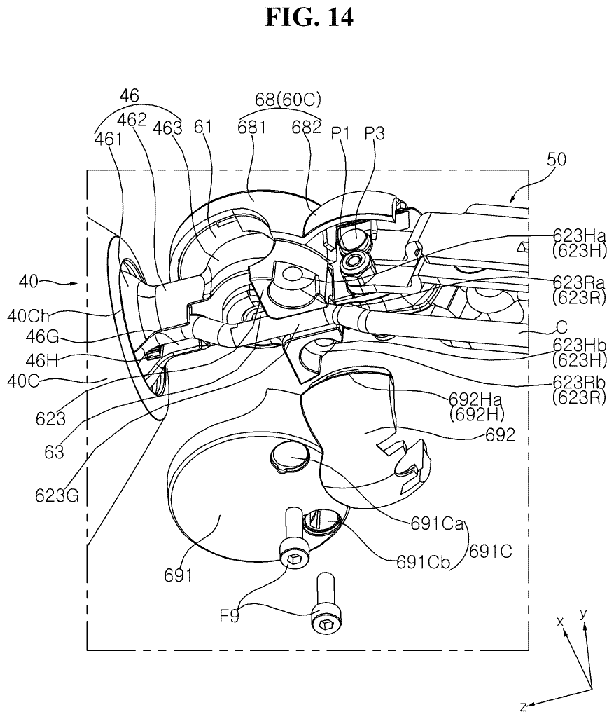

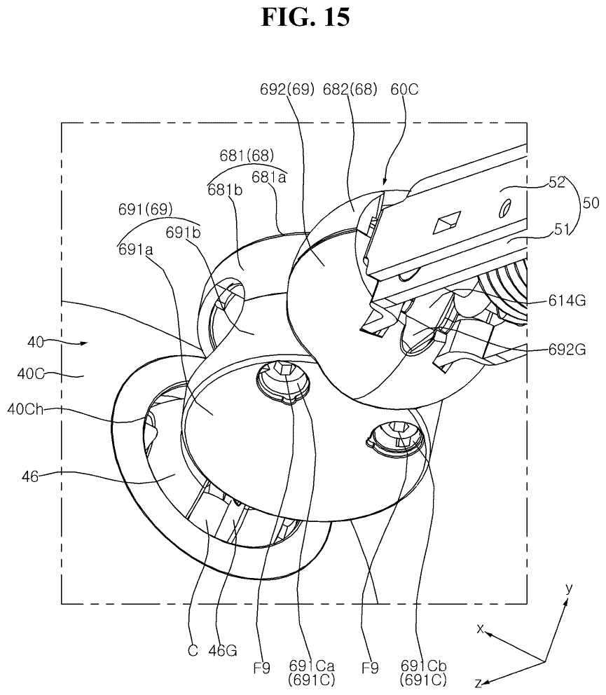

Referring to FIGS. 14 and 15 along with FIG. 11, the bottom cover 69 may include a bottom base 691 and a bottom dome 692.

The bottom base 691 may face a lower side of the lower body 62. The bottom base 691 may have a generally circular plate shape. A side wall 691b of the bottom base 691 may protrude upward from an edge of a bottom 691a of the bottom base 691, and may extend along the edge. A coupling portion 691C may protrude from an inner surface of the bottom 691a. The coupling portion 691C may be formed by being pressed upward from an outer surface of the bottom 691a. A first coupling portion 691Ca and a second coupling portion 691Cb may be spaced apart from each other.

The bottom dome 692 may extend rearward from the bottom base 691. The bottom dome 692 may cover the coupler 614 of the upper body 61. The bottom dome 692 may have a generally dome shape that is convex downward. A hole 692H or a groove 692H may be formed on a side surface of the bottom dome 692, and may be positioned to correspond to the protrusion 682P of the top dome 682. A first groove 692Ha may be formed on the left side of the bottom dome 692, and a second groove 692Hb may be formed on the right side of the bottom dome 692. The first protrusion 682Pa of the top dome 682 may be hooked into the first groove 692Ha. The second protrusion 682Pb of the top dome 682 may be hooked into the second groove 692Hb. Accordingly, the bottom cover 69 may be coupled to the top cover 68.

A cable groove 692G may be formed at an inner surface of the bottom dome 692, and may face a cable groove 614G of the coupler 614. The cable C may be disposed between the cable groove 692G of the bottom dome 692 and the cable groove 614G of the coupler 614.

A hole 623H may be formed on a lower surface of the lower wall 623 of the lower body 62. A groove 623R may be recessed from the lower surface of the lower wall 623, and the hole 623R may be formed in a bottom of the groove 623H. The coupling portion 691C of the bottom base 691 may be inserted into the groove 623R. The first coupling portion 691Ca may be aligned with a first hole 623Ha formed at a first groove 623Ra, and the second coupling portion 691Cb may be aligned with a second hole 623Hb formed at a second groove 623Rb. A fastening member F9 may pass through the coupling portion 691C of the bottom cover 69 and be coupled to the hole 623H. The fastening member F9 may be a bolt or a screw. Accordingly, the top cover 68 and the bottom cover 69 may be fixed to the joint 60.

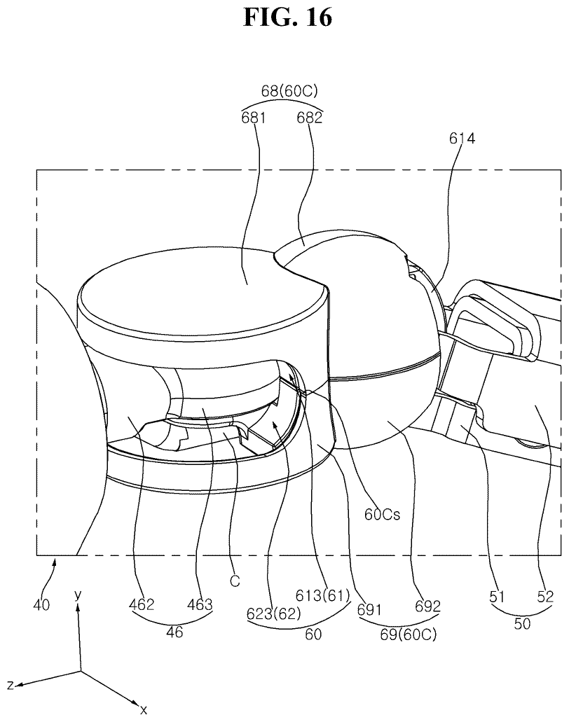

Referring to FIG. 16, the cover 60C may cover the joint 60. A slot 60CS may be formed at a front portion of a lateral surface of the cover 60C. The slot 60CS may be a U-shaped opening, and may have a length corresponding to a rotation trajectory of the holder 46. One end (or a first end) of the slot 60CS may be adjacent to one ends (or first ends) of the walls 613 and 623 of the joint 60. The other end (or a second end) of the slot 60CS may be adjacent to the other ends (or second ends) of the walls 613 and 623 of the joint 60. Accordingly, the holder 46 may rotate with respect to the joint 60 to which the cover 60C is coupled.

A cable C may be disposed between the bottom base 691 of the bottom cover 69 and the lower body 62 of the joint 60. In a rotational direction of the holder 46, a cable path may be formed between both ends of the lower wall 623. The cable C may be routed along the support arm 50 and the pole 30 (see FIG. 2), and may be electrically connected to the base 20 (see FIG. 2). A power cable connected to an external power source may be detachably connected to the base 20, and may be electrically connected to the cable C via the base 20. When the connector 40 is coupled to the base 20 (see FIG. 2), the cable C may be electrically connected to the display 10.

For example, the cable C may be electrically connected to a battery (not shown) of the display 10. The cable C may provide power to the battery of the display 10. In this case, when the display 10 is coupled to the connector 40, the battery of the display 10 may be charged. The display 10 separated from the connector 40 may be driven by power from the battery of the display 10.

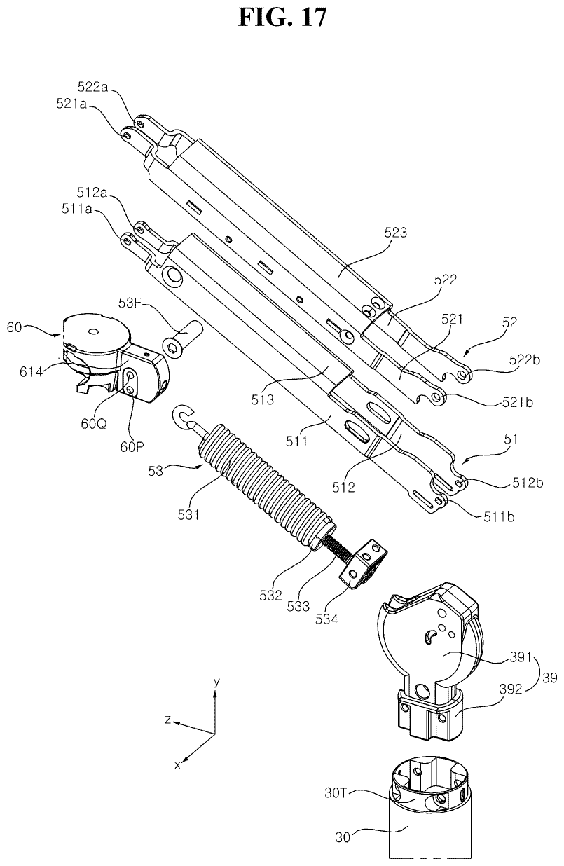

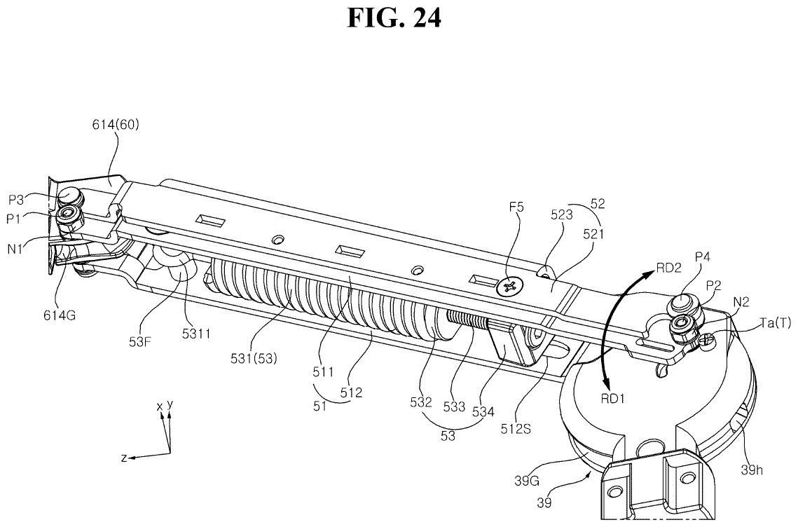

Referring to FIG. 17, the pole 30 may extend in the vertical direction. An arm mount 39 may be coupled to an upper end of the pole 30. The arm mount 39 may be referred to as a link mount 39, a mount 39, a hinge support 39, a bracket 39, or a clip 39. The arm mount 39 may include a head 391 and a body 392. The body 392 may be inserted and coupled to a top part 30T of the pole 30. A cable groove 39G (see FIG. 24) may be formed at a front portion of the arm mount 39, and a portion of the cable C (see FIG. 16) may be disposed in the cable groove 39G.

The support arm 50 may connect the arm mount 39 and the coupler 614. The support arm 50 may extend in a direction intersecting the pole 30. One end (or a first end) of the support arm 50 may be rotatably coupled to the arm mount 39. The other end (or a second end) of the support arm 50 may be rotatably coupled to the coupler 614. The support arm 50 may include a lower arm 51, an upper arm 52, and a supporter 53. The support arm 50 may be referred to as an arm 50 or a link 50. The lower arm 51 and the upper arm 52 may be collectively referred to as an inner arm 51, 52.

The lower arm 51 may extend along a longitudinal direction of the support arm 50. The lower arm 51 may include a first lower bar 511, a second lower bar 512, and a lower bridge 513. The first lower bar 511 and the second lower bar 512 may extend in a longitudinal direction of the lower arm 51, and may face each other. The first lower bar 511 and the second lower bar 512 may be spaced apart from each other in the horizontal direction. The lower bridge 513 may connect an upper side of the first lower bar 511 and an upper side of the second lower bar 512. The lower arm 51 may include a metal material. The lower arm 51 may be referred to as a first arm 51 or a lower bracket 51.

The upper arm 52 may extend along the lower arm 51. The upper arm 52 may include a first upper bar 521, a second upper bar 522, and an upper bridge 523. The first upper bar 521 and the second upper bar 522 may extend in a longitudinal direction of the upper arm 52, and may face each other. The first upper bar 521 and the second upper bar 522 may be spaced apart from each other in the horizontal direction. The upper bridge 523 may connect an upper side of the first upper bar 521 and an upper side of the second upper bar 522. The upper arm 52 may include a metal material. The upper arm 52 may be referred to as a second arm 52 or an upper bracket 52.

In addition, the upper arm 52 may cover a portion of the lower arm 51. The lower bars 511 and 512 of the lower arm 51 may be positioned between the upper bars 521 and 522 of the upper arm 52. The lower bridge 513 of the lower arm 51 may be positioned under the upper bridge 523 of the upper arm 52.

The supporter 53 may include an elastic member 531 having elasticity. The supporter 53 may be referred to as an elastic module 53 or a spring module 53. The elastic member 531 may be a spring in the form of a coil. The elastic member 531 may extend along the lower arm 51. The elastic member 531 may be stretched or compressed. The elastic member 531 may be disposed between the lower bars 511 and 512 of the lower arm 51.

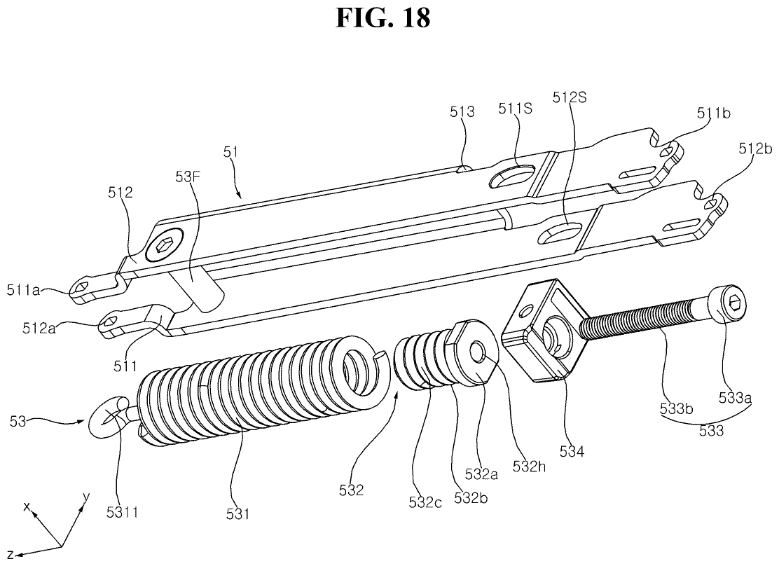

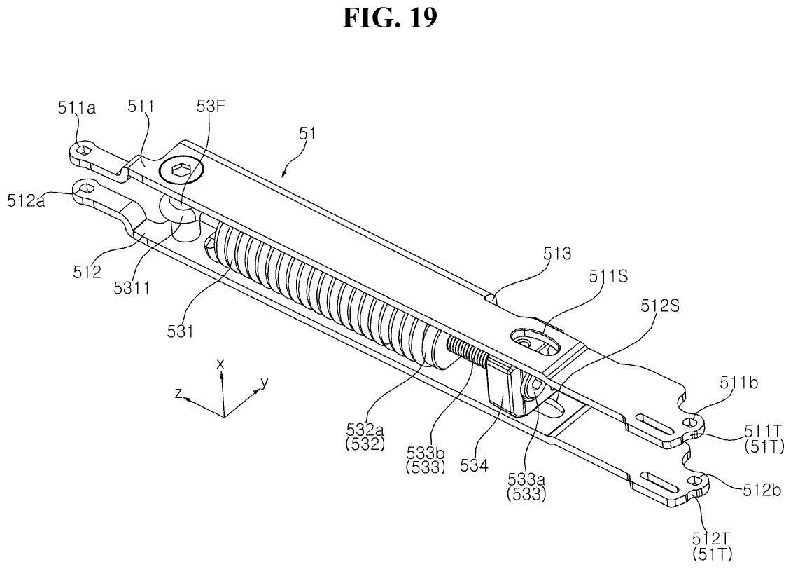

Referring to FIGS. 18 and 19, the supporter 53 may include an elastic member 531, a stopper 532, a shaft 533, and a block 534.

The elastic member 531 may be disposed between the lower bars 511 and 512 of the lower arm 51. The elastic member 531 may be a spring in the form of a coil. A fixer 53F may be adjacent to one end (or a first end) of the lower arm 51, and may extend in a direction intersecting the lower bars 511 and 512. The fixer 53F may be fixed to the lower bars 511 and 512. A portion 5311 of the elastic member 531 may be formed into a hook so that the hook may be engaged with the fixer 53F. In other words, one end (or a first end) of the elastic member 531 may be fixed to the fixer 53F.

The stopper 532 may be disposed opposite the fixer 53F with respect to the elastic member 531. The other end (or a second end) of the elastic member 531 may be positioned on the stopper 532. A head 532a of the stopper 532 may support the second end of the elastic member 531. A body 532b of the stopper 532 may extend from the head 532a, and may be inserted inside the elastic member 53. The body 532b may have a cylindrical shape, and a diameter of the body 532b may be less than a diameter of the head 532a. A groove 532c may be formed on an outer circumferential surface of the body 532b. The groove 532c may extend in a helix (or helical) shape, and the elastic member 531 may be positioned on the groove 532c. The elastic member 531 between the fixer 53F and the head 532a of the stopper 532 may be compressed or stretched.

The block 534 may be spaced apart from the head 532a of the stopper 532. The block 534 may be disposed between the lower bars 511 and 512 of the lower arm 51, and may not to be covered by the lower bridge 513.

The shaft 533 may extend in a direction intersecting the block 534. The shaft 533 may pass through the block 534 and be coupled to the stopper 532. A thread may be formed on an outer circumferential surface of a body 533b of the shaft 533, and the body 533b may be screw-coupled to an inner surface of a hole 532h of the stopper 532. A head 533a of the shaft 533 may be caught on the block 534. The shaft 533 may be a bolt.

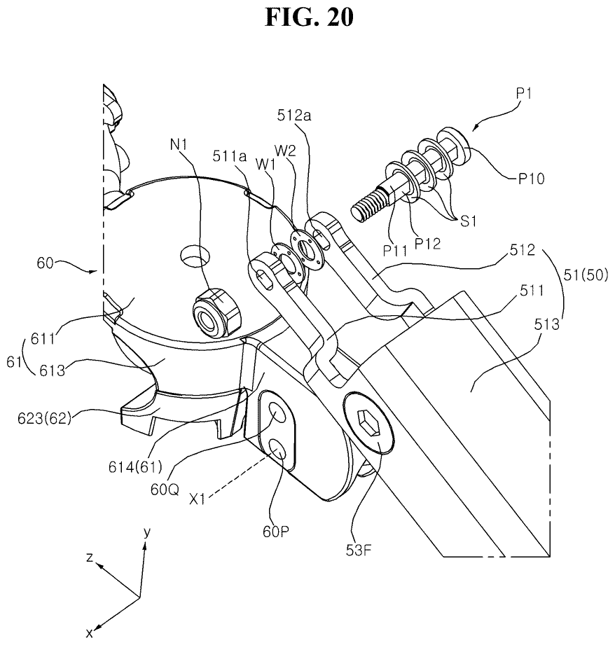

Referring to FIG. 20, the coupler 614 may be positioned between the lower bars 511 and 512 of the lower arm 51. A lower hole 60P and an upper hole 60Q may be formed in the coupler 614. The lower hole 60P may be spaced downward from the upper hole 60Q. The lower hole 60P and the upper hole 60Q may each be a circular hole.

A first hole 511a may be formed in the first lower bar 511 to be adjacent to one end (or a first end) of the first lower bar 511 of the lower arm 51. A first hole 512a may be formed in the second lower bar 512 to be adjacent to one end (or a first end) of the second lower bar 512 of the lower arm 51. The first holes 511a and 512a may each have a boundary with a linear section and a curved section. The first holes 511a and 512a may be aligned with the lower hole 60P (see reference numeral X1).

A first lower pin P1 may extend in a direction intersecting the lower bars 511 and 512. The first lower pin P1 may extend in the horizontal direction. The first lower pin P1 may be a bolt or a rivet. A diameter of a head P10 of the first lower pin P1 may be greater than a diameter of a body of the first lower pin P1. A lateral surface of the body of the first lower pin P1 may include a curved surface P11 and a flat surface P12. A cross-section of the body of the first lower pin P1 may have the same shape as the first holes 511a and 512a. The first lower pin P1 may pass through the first hole 512a, the lower hole 60P, and the first hole 511a.

A first lower fixer N1 may be coupled to the first lower pin P1, and may be opposite the head P10 of the first lower pin P1. The first lower fixer N1 may be a nut. A first washer W1 may be disposed between the first lower bar 511 and the coupler 614, and may have a circular hole through which the first lower pin P1 passes. A second washer W2 may be disposed between the second lower bar 512 and the coupler 614, and may have a circular hole through which the first lower pin P1 passes.

The joint 60 may rotate with respect to the first lower pin P1 fixed to the lower arm 51. Due to a frictional force between the coupler 614 of the joint 60 and the lower arm 51, a force of a predetermined magnitude or greater may be required to rotate the joint 60. A disc spring S1 may be disposed between the head P10 of the first lower pin P1 and the second lower bar 512, or may be disposed between the first lower fixer N1 and the first lower bar 511. The first lower pin P1 may pass through the disc spring S1. The disc spring S1 may be convex toward the head P10 of the first lower pin P1 or the first lower fixer N1, and may have elasticity. The disc spring S1 may generate an elastic force in an axial direction, thereby increasing the frictional force between the coupler 614 and the lower arm 51.

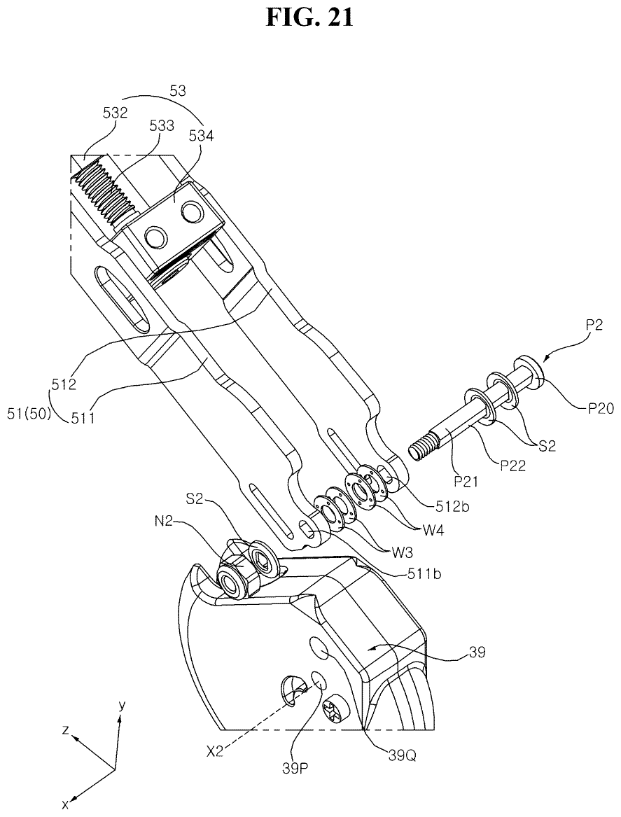

Referring to FIG. 21, the arm mount 39 may be positioned between the lower bars 511 and 512 of the lower arm 51. A lower hole 39P and an upper hole 39Q may be formed in the arm mount 39. The lower hole 39P may be spaced downward from the upper hole 39Q. The lower hole 39P and the upper hole 39Q may each be a circular hole.

A second hole 511b may be formed in the first lower bar 511 to be adjacent to the other end (or a second end) of the first lower bar 511 of the lower arm 51. A second hole 512b may be formed in the second lower bar 512 to be adjacent to the other end (or a second end) of the second lower bar 512 of the lower arm 51. The second holes 511b and 512b may each have a boundary with a linear section and a curved section. The second holes 511b and 512b may be aligned with the lower hole 39P (see reference numeral X2).

A second lower pin P2 may extend in a direction intersecting the lower bars 511 and 512. The second lower pin P2 may extend in the horizontal direction. The second lower pin P2 may be a bolt or a rivet. A diameter of a head P20 of the second lower pin P2 may be greater than a diameter of a body of the second lower pin P2. A lateral surface of the body of the second lower pin P2 may include a curved surface P21 and a flat surface P22. A cross-section of the body of the second lower pin P2 may have the same shape as the second holes 511b and 512b. The second lower pin P2 may pass through the second hole 512b, the lower hole 39P, and the second hole 511b.

A second lower fixer N2 may be coupled to the second lower pin P2, and may be opposite the head P20 of the second lower pin P2. The second lower fixer N2 may be a nut. A first washer W3 may be disposed between the first lower bar 511 and the arm mount 39, and may have a circular hole through which the second lower pin P2 passes. A second washer W4 may be disposed between the second lower bar 512 and the arm mount 39, and may have a circular hole through which the second lower pin P2 passes.

The lower arm 51 may rotate with respect to the arm mount 39. The second lower pin P2 fixed to the lower arm 51 may be parallel to the axis of rotation of the lower arm 51. Due to a frictional force between the lower arm 51 and the arm mount 39, a force of a predetermined magnitude or greater may be required to rotate the lower arm 51. A disc spring S2 may be disposed between the head P20 of the second lower pin P2 and the second lower bar 512, or may be disposed between the second lower fixer N2 and the first lower bar 511. The second lower pin P2 may pass through the disc spring S2. The disc spring S2 may be convex toward the head P20 of the second lower pin P2 or the second lower fixer N2, and may have elasticity. The disc spring S2 may generate an elastic force in an axial direction, thereby increasing the frictional force between the lower arm 51 and the arm mount 39.

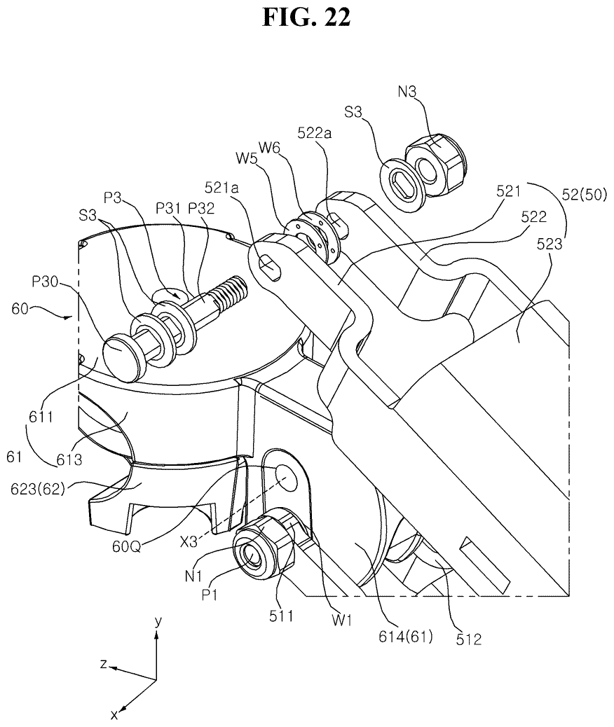

Referring to FIG. 22, the coupler 614 may be positioned between the upper bars 521 and 522 of the upper arm 52.

A first hole 521a may be formed in the first upper bar 521 to be adjacent to one end (or a first end) of the first upper bar 521 of the upper arm 52. A first hole 522a may be formed in the second upper bar 522 to be adjacent to one end (or a first end) of the second upper bar 522 of the upper arm 52. The first holes 521a and 522a may each have a boundary with a linear section and a curved section. The first holes 521a and 522a may be aligned with the upper hole 60Q (see reference numeral X3).

A first upper pin P3 may extend in a direction intersecting the upper bars 521 and 522. The first upper pin P3 may extend in the horizontal direction. The first upper pin P3 may be a bolt or a rivet. A diameter of a head P30 of the first upper pin P3 may be greater than a diameter of a body of the first upper pin P3. A lateral surface of the body of the first upper pin P3 may include a curved surface P31 and a flat surface P32. A cross-section of the body of the first upper pin P3 may have the same shape as the first holes 521a and 522a. The first upper pin P3 may pass through the first hole 521a, the upper hole 60Q, and the first hole 522a.

A first upper fixer N3 may be coupled to the first upper pin P3, and may be opposite the head P30 of the first upper pin P3. The first upper fixer N3 may be a nut. A first washer W5 may be disposed between the first upper bar 521 and the coupler 614, and may have a circular hole through which the first upper pin P3 passes. A second washer W6 may be disposed between the second upper bar 522 and the coupler 614, and may have a circular hole through which the first upper pin P3 passes.

The joint 60 may rotate with respect to the first upper pin P3 fixed to the upper arm 52. Due to a frictional force between the coupler 614 of the joint 60 and the upper arm 52, a force of a predetermined magnitude or greater may be required to rotate the joint 60. A disc spring S3 may be disposed between the head P30 of the first upper pin P3 and the first upper bar 521, or may be disposed between the first upper fixer N3 and the second upper bar 522. The first upper pin P3 may pass through the disc spring S3. The disc spring S3 may be convex toward the head P30 of the first upper pin P3 or the first upper fixer N3, and may have elasticity. The disc spring S3 may generate an elastic force in an axial direction, thereby increasing the frictional force between the coupler 614 and the upper arm 52.

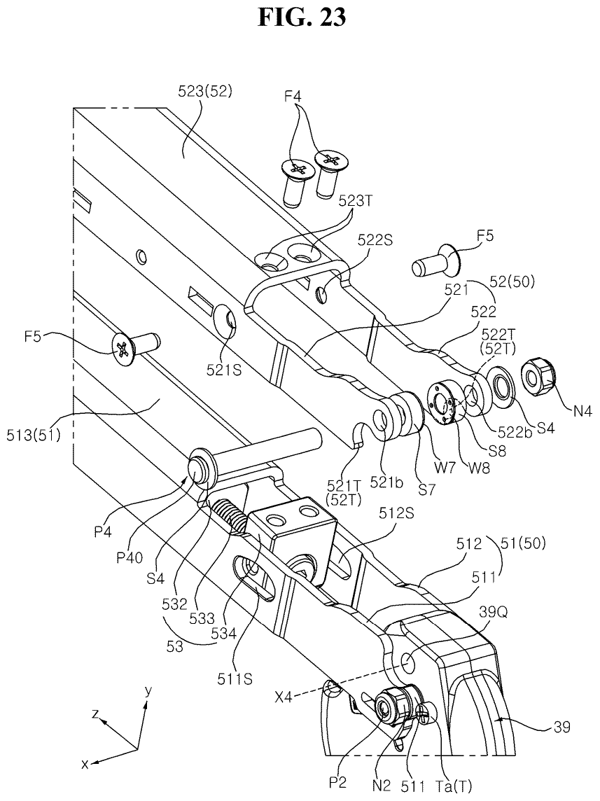

Referring to FIG. 23, the arm mount 39 may be positioned between the upper bars 521 and 522 of the upper arm 52.

A second hole 521b may be formed in the first upper bar 521 to be adjacent to the other end (or a second end) of the first upper bar 521 of the upper arm 52. A second hole 522b may be formed in the second upper bar 522 to be adjacent to the other end (or a second end) of the second upper bar 522 of the upper arm 52. The second holes 521b and 522b may each be a circular hole. The second holes 521b and 522b may be aligned with the upper hole 39Q (see reference numeral X4).

A second upper pin P4 may extend in a direction intersecting the upper bars 521 and 522. The second upper pin P4 may extend in the horizontal direction. The second upper pin P4 may be a bolt or a rivet. A diameter of a head P40 of the second upper pin P4 may be greater than a diameter of a body of the second upper pin P4. A cross-section of the body of the second upper pin P4 may have the same shape as the second holes 521b and 522b. The second upper pin P4 may pass through the second hole 521b, the upper hole 39Q, and the second hole 522b.

A second upper fixer N4 may be coupled to the second upper pin P4, and may be opposite the head P40 of the second upper pin P4. The second upper fixer N4 may be a nut. A first washer W7 may be disposed between the first upper bar 521 and the arm mount 39, and the second upper pin P4 may pass through the first washer W7. A first spacer S7 may be disposed between the first upper bar 521 and the first washer W7, and the second upper pin P4 may pass through the first spacer S7. A second washer W8 may be disposed between the second upper bar 522 and the arm mount 39, and the second upper pin P4 may pass through the second washer W8. A second spacer S8 may be disposed between the second upper bar 522 and the second washer W8, and the second upper pin P4 may pass through the second spacer S8.

The upper arm 52 may rotate with respect to the arm mount 39. The upper arm 52 may rotate about the second upper pin P4. Due to a frictional force between the upper arm 52 and the arm mount 39, a force of a predetermined magnitude or greater may be required to rotate the upper arm 52. A disc spring S4 may be disposed between the head P40 of the second upper pin P4 and the first upper bar 521, or may be disposed between the second upper fixer N4 and the second upper bar 522. The second upper pin P4 may pass through the disc spring S4. The disc spring S4 may be convex toward the head P40 of the second upper pin P4 or the second upper fixer N4, and may have elasticity. The disc spring S4 may generate an elastic force in an axial direction, thereby increasing the frictional force between the upper arm 52 and the arm mount 39.

Referring to FIGS. 23 and 24, the upper bridge 523 of the upper arm 52 may cover the block 534 of the supporter 53.

A fastening member F4 may pass through a top hole 523T of the upper bridge 523 and be coupled to the block 534. The fastening member F4 may be a screw. Accordingly, the block 534 may be fixed to the upper arm 52.

Fastening members F5 may pass through side holes 521S, 522S of the upper bars 521, 522 and slots 511S, 512S of the lower bars 511, 512 and be coupled to the block 534. The fastening members F5 and the block 534 may move along the slots 511S and 512S. Each of the slots 511S and 512S may be curved. The slots 511S and 512S may have a curvature corresponding to a rotation trajectory of the lower arm 51. Accordingly, the block 534 may be movably coupled to the lower arm 51.

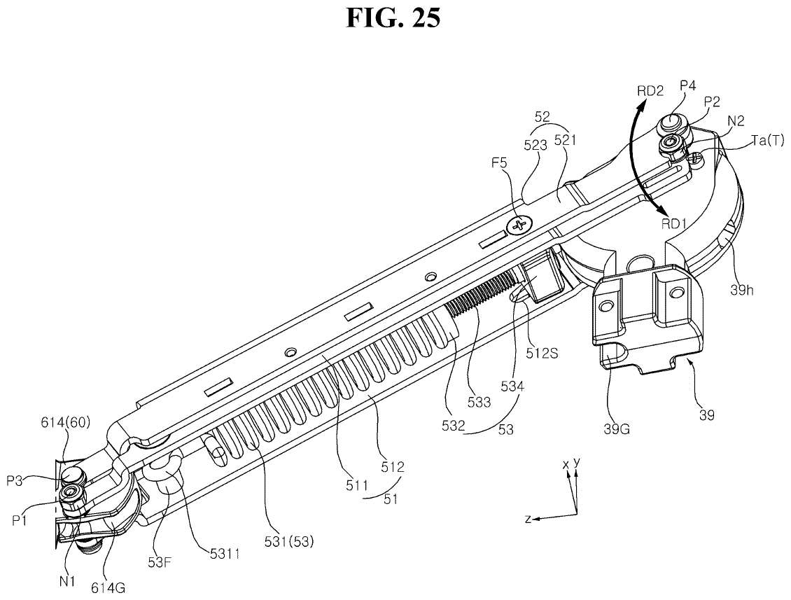

Referring to FIGS. 24 and 25, the support arm 50 may rotate with respect to the arm mount 39. The rotation of the support arm 50 with respect to the arm mount 39 may be referred to as tilting of the support arm 50. The coupler 614 of the joint 60 may rotate with respect to the support arm 50.

The lower arm 51 may rotate about an axis parallel to the second lower pin P2. The upper arm 52 may rotate about an axis parallel to the second upper pin P4. The joint 60 may rotate about an axis parallel to the first lower pin P1. The joint 60 may rotate about an axis parallel to the first upper pin P3.

The elastic member 531 of the supporter 53 may be variable in length according to the rotation (tilting) of the support arm 50. The supporter 53 may provide a force that can offset the moment acting on the support arm 50 from the joint 60.

For example, referring to FIG. 24 and FIG. 25 in order, the support arm 50 may rotate in a first rotational direction RD1. That is, the support arm 50 may be tilted downward. In response to this, the block 534 may move rearward along the slot 512S. In this case, the stopper 532 may move rearward together with the block 534, and the elastic member 531 may be elastically deformed to be stretched (extended). The support arm 50 may remain tilted downward by the force provided by the elastic member 531.

For example, referring to FIG. 24 and FIG. 25 in reverse order, the support arm 50 may rotate in a second rotational direction RD2. That is, the support arm 50 may be tilted upward. In response to this, the block 534 may move forward along the slot 512S. In this case, the stoper 532 may move forward together with the block 534, and the elastic member 531 may be elastically restored. The support arm 50 may remain tilted upward by the force provided by the elastic member 531.

The lower arm 51, the upper arm 52, and the pins P1, P2, P3, P4 may be a four-bar linkage that connects the joint 60 and the arm mount 39. For example, a distance between a central axis of the first lower pin P1 and a central axis of the first upper pin P3 may be equal to a distance between a central axis of the second lower pin P2 and a central axis of the second upper pin P4. In this case, regardless of the tilted angle of the support arm 50, the angle of the joint 39 with respect to the arm mount 39 may remain constant. For example, the angle of the joint 60 may be an angle between a vertical axis passing through a center of the arm mount 39 and an upper surface of the coupler 614 of the joint 60. Accordingly, the angle of the display 10 coupled to the joint 60 may also remain constant.

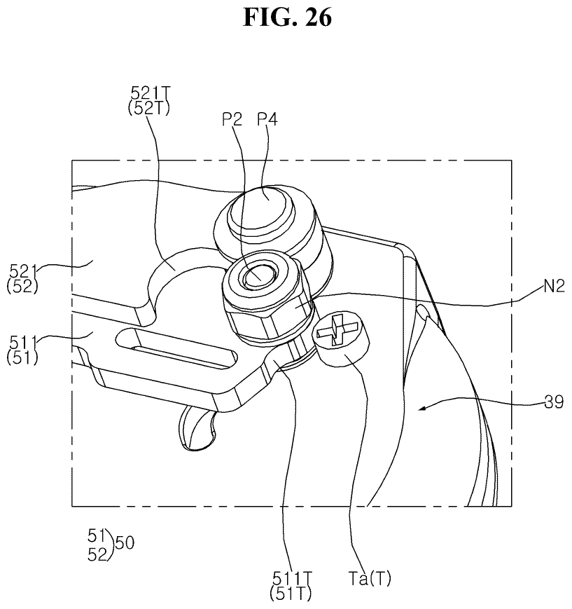

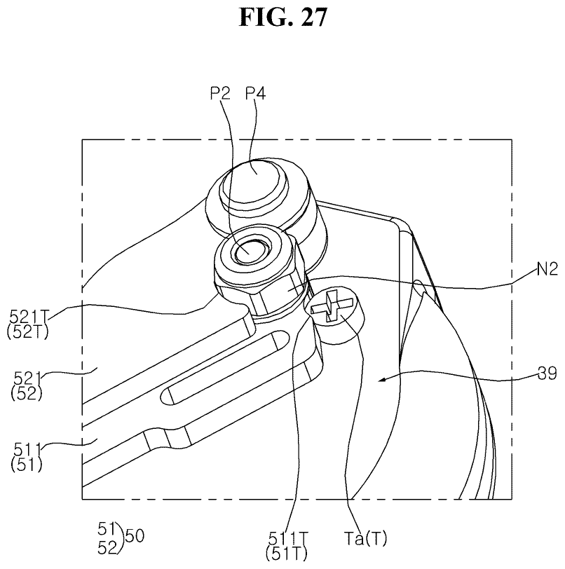

Referring to FIGS. 26 and 27 along with FIGS. 19 and 23, a lower groove 51T may be formed in the first lower bar 511 and/or the second lower bar 512. A first lower groove 511T may be formed at a rear end of the first lower bar 511. A second lower groove 512T may be formed at a rear end of the second lower bar 512.

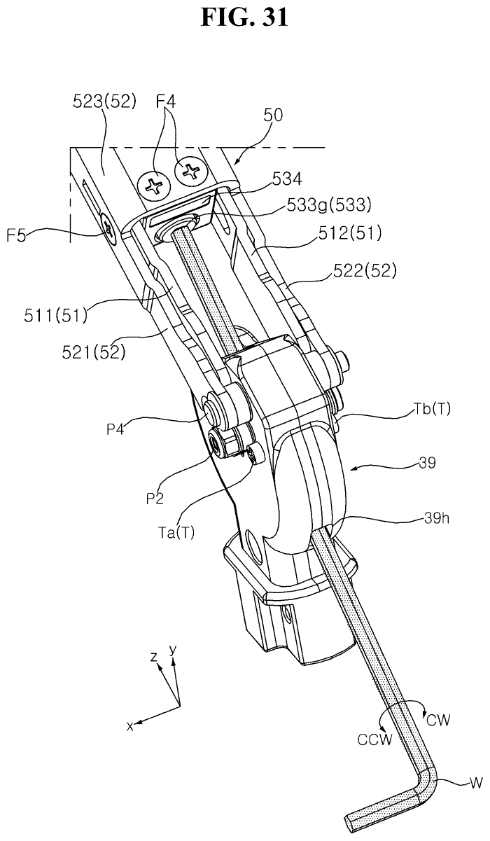

A stopper T may be coupled to or formed on a left side surface and/or a right side surface of the arm mount 39. The stopper T may be a head of a screw that is fixed to the arm mount 39. The stopper T may protrude from a side surface of the arm mount 39. A first stopper Ta may protrude from the left side surface of the arm mount 39. A second stopper Tb (see FIG. 31) may protrude from the right side surface of the arm mount 39. The stopper T may be located on a rotation trajectory of the lower groove 51T. The lower groove 51T may be a groove having a shape corresponding to a lateral surface of the stopper T.

The tilting (down) of the support arm 50 may be restricted as the lower groove 51T contacts the stopper T. That is, when the first lower groove 511T contacts the first stopper Ta or when the second groove 512T contacts the second stopper Tb, the tilting (down) of the support arm 50 may be stopped.

An upper groove 52T may be formed in the first upper bar 521 and/or the second upper bar 522. A first upper groove 521T may be formed at a rear end of the first upper bar 521. A second upper groove 522T may be formed at a rear end of the second upper bar 522.

A second lower fixer N2 may be located on a rotation trajectory of the first upper groove 521T. The first upper groove 521T may be a groove having a shape corresponding to a lateral surface of the second lower fixer N2. The head P20 (see FIG. 21) of the second lower pin P2 may be located on a rotation trajectory of the second upper groove 522T. The second upper groove 522T may be a groove having a shape corresponding to a lateral surface of the head P20.

The tilting (down) of the support arm 50 may be restricted as the upper groove 52T contacts the second lower fixer N2 or the head P20 of the second lower pin P2. That is, when the first upper groove 521T contacts the second lower fixer N2 or when the second upper groove 522T contacts the head P20 of the second lower pin P2, the tilting (down) of the support arm 50 may be stopped.

Accordingly, the lower arm 51 and the upper arm 52 may each have a groove to restrict the tilting (down) of the support arm 50. Alternatively, only one of the lower arm 51 and the upper arm 52 may have a groove to restrict the tilting (down) of the support arm 50.

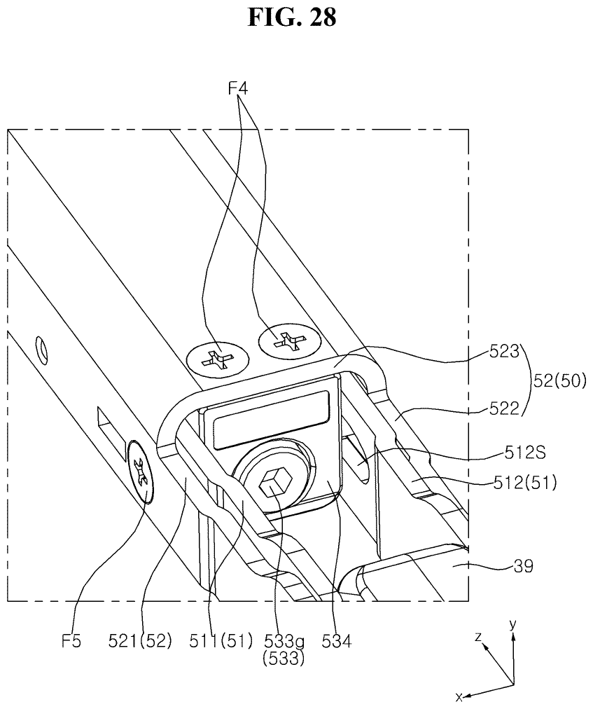

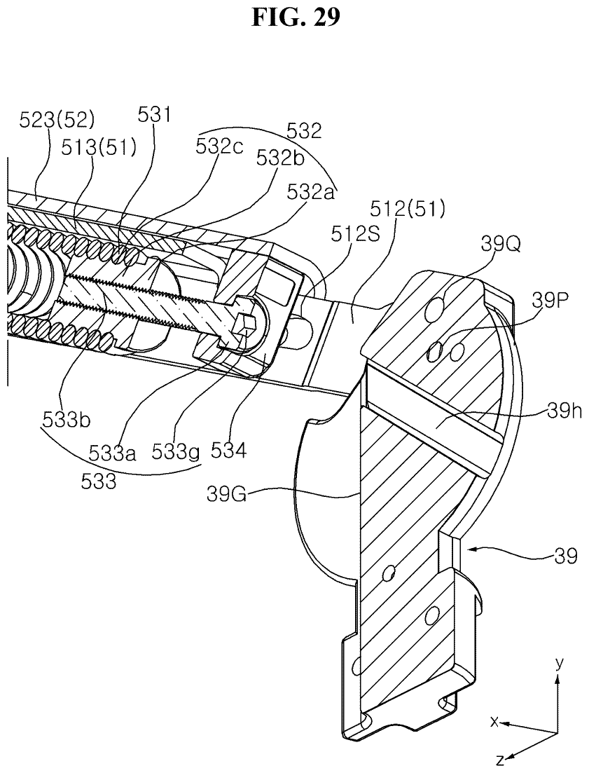

Referring to FIGS. 28 and 29, a groove 533g may be formed in the head 533a of the shaft 533. For example, the groove 533g may be a hexagonal groove.

A through-hole 39h may be formed in the arm mount 39. The through-hole 39h may be formed through the arm mount 39 in an oblique manner. The through-hole 39h may be referred to as a channel 39h or a path 39h. In a longitudinal direction of the through-hole 39h, the groove 533g of the shaft 533 may be positioned to correspond to the through-hole 39h. A longitudinal axis of the through-hole 39h may be inclined downward from a central axis of the shaft 533 by approximately 10 degrees. The groove 533g of the shaft 533 may be visible through the through-hole 39h.

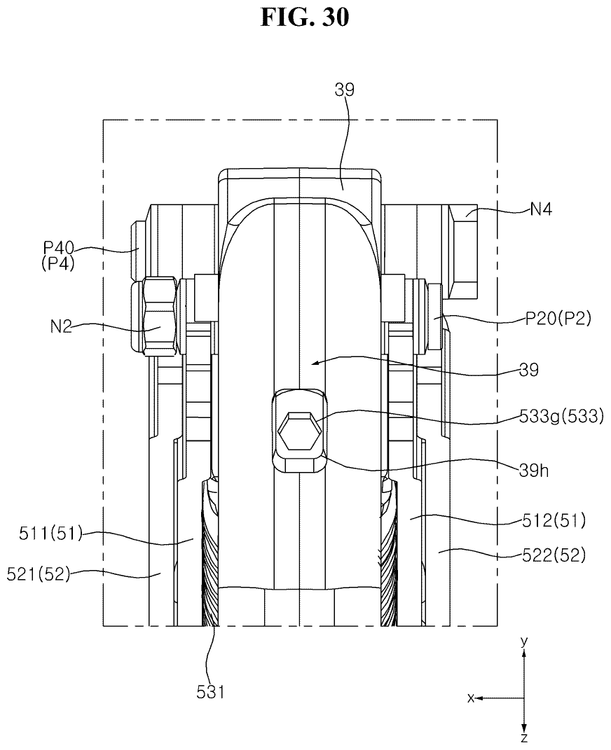

Referring to FIGS. 30 and 31 along with FIG. 29, a user may engage a tool W with the groove 533g of the shaft 533 through the through-hole 39. For example, the tool W may be a hex wrench. The tool W may be referred to as an L-shaped wrench. A user may rotate the shaft 533 using the tool W to adjust the position of the stopper 532. The elastic member 531 may be disposed between the fixer 53F and the head 532a of the stopper 532. Both side surfaces of the head 532a of the stopper 532 may contact the lower bars 511 and 512 of the lower arm 51, such that rotation of the head 532a may be restricted by the lower bars 511 and 512. The shaft 533 may be screw-coupled to an inner surface of a hole of the stopper 532 through which the shaft 533 passes, and the stopper 533 may linearly reciprocates along the shaft 533 in response to rotation of the shaft 533.

When a user rotates the tool W and the shaft 533 in a clockwise direction CW, the stopper 532 may be moved toward the fixer 53F (see FIG. 19), and, in response to this, the elastic member 531 may be compressed to a length close to its original length. Alternatively, when the shaft 533 is rotated counterclockwise, the stopper 532 may be moved toward the fixer 53F (see FIG. 19).

When a user rotates the tool W and the shaft 533 in a counterclockwise direction CCW, the stopper 532 may be moved toward the block 534, and, in response to this, the elastic member 531 may be further stretched as it is elastically deformed. Alternatively, when the shaft 533 is rotated clockwise, the stopper 532 may be moved toward the block 534.

Thus, a user can adjust the tension of the elastic member 531 by using the tool W. As such, by adjusting the force applied to the elastic member 531, a user can change the magnitude of force required to tilt the support arm 50. In other words, a user can adjust the tilting of the support arm 50 more smoothly or more tightly.

Referring to FIGS. 1 to 31, a display device 1 may include: a display panel 11; an arm mount 39 spaced apart from the display panel 11; and a support arm 50 to connect the display panel 11 and the arm mount 39. The support arm 50 may include: a lower arm 51 rotatably coupled to the display panel 11 and the arm mount 39; an upper arm 52 adjacent to the lower arm 51 and rotatably coupled to the display panel 11 and the arm mount 39; and a supporter 53 to support rotation of the support arm 50 with respect to the arm mount 39.

A display device may include: a display 10; a stand S including: a base 20; a pole 30 coupled to the base 20 and extending vertically; and a support arm 50 extending in a direction intersecting the pole 30, connecting the pole 30 and the display 10, and including an elastic member 531, and an arm mount 39 which is coupled to a top of the pole 30 and to which the support arm 50 is tiltably coupled, wherein the arm mount 39 may include a through-hole 39h for changing a tension of the elastic member 531.

A first side of the supporter 53 may be coupled to the lower arm 51, and a second side of the supporter 53 may be coupled to the upper arm 52.

The lower arm 51 may cover the supporter 53, and the upper arm 52 may cover the lower arm 51.

The supporter 53 may include: an elastic member 531 disposed within the lower arm 51; a fixer 53F fixed to the lower arm 51 to be adjacent to a first end of the lower arm 51 and to which a first end of the elastic member 531 is fixed; a stopper 532 disposed opposite the fixer 53F with respect to the elastic member 531 and on which a second end of the elastic member 531 is positioned; a block 534 spaced apart from the stopper 532 and fixed to the upper arm 52; and a shaft 533 to connect the stopper 532 and the block 534.

The block 534 may be movably coupled to the lower arm 51.

The display device 1 may further include a fastening member F5 coupled to the block 534. The lower arm 51 may include a lower bar 511 including a slot 511S that is curved, the lower bar 511 facing a side surface of the block 534. The upper arm 52 may include an upper bar 521 including a side hole 521S, the upper bar 521 facing the lower bar 511. The fastening member F5 may be fixed to the block 534 through the side hole 521S and the slot 511S, and may be movable along the slot 511S.

The shaft 533 may be inserted into a hole 532h of the stopper 532, and may be screw-coupled to an inner surface of the hole 532h. In response to rotation of the shaft 533, the stopper 532 may be configured to move in a direction toward the fixer 53F or move in a direction away from the fixer 53F.

The elastic member 531 may be a coil spring. The stopper 532 may include: a head 532a to support the second end of the elastic member 531; and a body 532b inserted inside the elastic member 531 from the head 532a, the body 532b having a helix-shaped groove 532c on which the elastic member 531 is positioned.

The shaft 533 may include a groove 533g formed in a head 533 a of the shaft 533. The arm mount 39 may include a through-hole 39h formed in the arm mount 39. The through-hole 39h and the groove 533g may be aligned on a same straight line.

The lower arm 51 may include: a pair of lower bars 511, 512 disposed opposite each other with respect to the arm mount 39; and a lower bridge 513 to connect the pair of lower bars 511, 512. The upper arm 52 may include: a pair of upper bars 521, 522 disposed opposite each other with respect to the arm mount 39; and an upper bridge 523 to connect the pair of upper bars 521, 522. The lower bar 511 may be positioned between the upper bar 521 and the arm mount 39.

The display device 1 may further include: an upper pin P4 to rotatably couple the upper bar 521 to the arm mount 39; a lower pin P2 to rotatably couple the lower bar 511 to the arm mount 39; and a lower fixer N2 fixed to an end of the lower pin P2. The upper bar 521 may include an upper groove 521T formed in the upper bar 521 and corresponding to the lower fixer N2. Rotation of the upper bar 521 may be restricted as the upper groove 521T contacts the lower fixer N2.

The display device 1 may further include a stopper Ta protruding from a side surface of the arm mount 39. The lower bar 511 may include a lower groove 511T formed in the lower bar 511 and corresponding to the stopper Ta. Rotation of the lower bar 511 may be restricted as the lower groove 511T contacts the stopper Ta.

The display device 1 may further include a joint 60 to couple the lower arm 51 and the upper arm 52. A first end of the lower arm 51 and a first end of the upper arm 52 may be rotatably coupled to the joint 60, and a second end of the lower arm 51 and a second end of the upper arm 52 may be rotatably coupled to the arm mount 39.

A distance between the first end of the lower arm 51 and the first end of the upper arm 52 may be equal to a distance between the second end of the lower arm 51 and the second end of the upper arm 52.

The display device 1 may further include: a cover 60C to cover the joint 60; and a cable C disposed between the joint 60 and the cover 60C.

A display device 1 may include: a display 10; a joint 60 coupled to a rear of the display 10; an arm mount 39 spaced apart from the joint 60; a support arm 50 to connect the joint 60 and the arm mount 39; a cover 60C to cover the joint 60; and a cable C disposed between the joint 60 and the cover 60C.

The display device according to the present disclosure has the following effects.

According to at least one of the embodiments of the present disclosure, it is possible to provide a display device including a stand for supporting a display.

According to at least one of the embodiments of the present disclosure, it is possible to provide a structure for freely adjusting the angle or height of a display.

According to at least one of the embodiments of the present disclosure, it is possible to provide a rotational structure of a support arm of a display.

According to at least one of the embodiments of the present disclosure, it is possible to provide a structure for supporting rotation of a support arm.

According to at least one of the embodiments of the present disclosure, it is possible to provide a structure for adjusting the tension of an elastic member of a support arm.

According to at least one of the embodiments of the present disclosure, it is possible to provide a stopper structure for restricting rotation of a support arm.

According to at least one of the embodiments of the present disclosure, it is possible to provide a joint structure for connecting a support arm to a display.

According to at least one of the embodiments of the present disclosure, it is possible to provide a structure in which a cable is disposed between a joint and a joint cover.

Certain embodiments or other embodiments of the invention described above are not mutually exclusive or distinct from each other. Any or all elements of the embodiments of the invention described above may be combined or combined with each other in configuration or function.

For example, a configuration “A” described in one embodiment of the invention and the drawings and a configuration “B” described in another embodiment of the invention and the drawings may be combined with each other. Namely, although the combination between the configurations is not directly described, the combination is possible except in the case where it is described that the combination is impossible.

The foregoing embodiments are merely examples and are not to be considered as limiting the present disclosure. The scope of the present disclosure should be determined by rational interpretation of the appended claims, and all modifications within the equivalents of the disclosure are intended to be included within the scope of the present disclosure.

What is claimed is:

1. A display device comprising:
a display;
a stand including:
a base;
a pole coupled to the base and extending vertically; and
a support arm extending in a direction intersecting the pole, connecting the pole and the display, and including an elastic member, and
an arm mount which is coupled to a top of the pole and to which the support arm is tiltably coupled,
wherein the arm mount comprises a through-hole for changing a tension of the elastic member.

2. The display device of claim 1, wherein the support arm comprises:
a lower arm tiltably coupled to the display; and
an upper arm extending along the lower arm, covering the lower arm, and tiltably coupled to the display.

3. The display device of claim 2, wherein the elastic member is positioned inside the lower arm,
wherein the supporter further comprises:
a fixer adjacent a first end of the lower arm, fixed to the lower arm, and to which a first end of the elastic member is fixed;
a stopper opposite the fixer with respect to the elastic member and on which a second end of the elastic member is positioned;
a block spaced apart from the stopper and fixed to the upper arm; and
a shaft connecting the stopper and the block.

4. The display device of claim 3, wherein the block is movably coupled to the lower arm.

5. The display device of claim 3, wherein the elastic member comprises a hook forming the first end of the elastic member and detachably coupled to the fixer.

6. The display device of claim 4, further comprising a fastening member coupled to the block,
wherein the lower arm comprises a lower bar including a slot which is curved, the lower bar facing a side surface of the block,
wherein the upper arm comprises an upper bar including a side hole, the upper bar facing the lower bar, and
wherein the fastening member is fixed to the block through the side hole and the slot, and is movable along the slot.

7. The display device of claim 3, wherein the shaft is inserted into a hole of the stopper and is screw-coupled to an inner surface of the hole, and
wherein, in response to rotation of the shaft, the stopper moves in a direction toward the fixer or move in a direction away from the fixer.

8. The display device of claim 7, wherein the elastic member is a coil spring, and
wherein the stopper comprises:
a head supporting the second end of the elastic member; and
a body inserted inside the elastic member from the head, the body including a helix-shaped groove on which the elastic member is positioned.

9. The display device of claim 7, wherein the shaft comprises a groove formed in a head of the shaft,
wherein the through-hole and the groove are aligned on a same straight line.

10. The display device of claim 2, wherein the lower arm comprises:
a pair of lower bars opposite each other with respect to the arm mount; and
a lower bridge connecting the pair of lower bars,
wherein the upper arm comprises:
a pair of upper bars opposite each other with respect to the arm mount; and
an upper bridge connecting the pair of upper bars, and
wherein the lower bar is disposed between the upper bar and the arm mount.

11. The display device of claim 10, further comprising:
an upper pin which rotatably couples the upper bar to the arm mount;
a lower pin which rotatably couples the lower bar to the arm mount; and
a lower fixer fixed to an end of the lower pin,
wherein the upper bar comprises an upper groove formed at the upper bar, and corresponding to the lower fixer, and
wherein rotation of the upper bar is restricted as the upper groove contacts the lower fixer.

12. The display device of claim 10, further comprising a stopper protruding from a side surface of the arm mount,
wherein the lower bar comprises a lower groove formed at the lower bar, and corresponding to the stopper, and
wherein rotation of the lower bar is restricted as the lower groove contacts the stopper.

13. The display device of claim 2, further comprising a joint coupling the lower arm and the upper arm to the display,
wherein:
a first end of the lower arm and a first end of the upper arm are rotatably coupled to the joint; and
a second end of the lower arm and a second end of the upper arm are rotatably coupled to the arm mount.

14. The display device of claim 13, wherein a distance between the first end of the lower arm and the first end of the upper arm is equal to a distance between the second end of the lower arm and the second end of the upper arm.

15. The display device of claim 13, further comprising:
a cover covering the joint and including a bottom cover; and
a cable disposed between the joint and the bottom cover.

16. The display device of claim 13, further comprising a connector coupled to a rear surface of the display,
wherein the connector is rotatably coupled to the joint.

17. The display device of claim 1, wherein the display comprises a battery providing power for driving the display.

18. The display device of claim 9, wherein a longitudinal axis of the through-hole is inclined downward at a certain angle with respect to a central axis of the shaft.

19. The display device of claim 1, further comprising:
a joint coupling the support arm to the display;
a cover covering the joint and including a bottom cover; and
a cable disposed between the joint and the bottom cover.

20. The display device of claim 19, wherein the joint comprises an upper body and a lower body,
wherein the lower body comprises a cable groove formed at a lower surface of the lower body and in which the cable is disposed.
